(19) United States
(12) Patent Application Publication
(10) Pub. No.: US 2006/0048810 A1
(43) Pub. Date: Mar. 9, 2006

(54) Solar electricity generator consisting of groups of plants

(76) Inventors: Nikolaus Johannes Laing, La Jolla, CA (US); Inge Laing, La Jolla, CA (US)

Correspondence Address: Nikolaus Johannes Laing, 1253 La Jolla Rancho Road, La Jolla, CA, 92037, US

(21) Appl. No.: 10/935,396

(22) Filed: Sep. 8, 2004

(51) Int. Cl. H01L 25/00

(52) U.S. Cl. 136/246

(57) ABSTRACT

The invention describes large solar power plants, which consist of groups of rotating platforms. Three of said platforms comprising a triad having an interstitial pillar, said pillar has means to transmit torque to rotate the platforms and means to maintain the position of the platforms.

### PRIOR APPLICATION

In the PCT-patent application WO 03/134506 A2, a solar electricity-generating platform is disclosed that azimuth-tracks the sun's diurnal motion. The diameter of this platform is restricted only by a requirement for the low drag of laminar flow of the water around the rotating platform.

### SUMMARY OF THE INVENTION

For covering large tracks of land, the invention therefore combines a plurality of swiveling platforms into a large power plant. For close packing, the platforms must be circular. They float on a shallow (14″) water body large enough to contain all the platforms. A small distance between the platforms allows maintenance personal to reach any platform by wading through the shallow water layer. They are grouped into triads that are moved by a central pillar anchored within a slab of cement. This pillar has several functions:

It contains a bearing with a central drive-wheel and a geared motor. In conjunction with this drive wheel, guide rollers are anchored within the slab-socket. The guide wheels roll on a small ring-region below the floating ring of the platform and fix the position of the platform within the water body. Thus the position of each platform will be set by its pillar.

The electrical output of each platform is conducted by highly flexible leads that leave each platform from its center and go to the pillar, and there from by submerged conduits to the edge of the body of water.

From each pillar, spray beams protrude to reach to the center of each of the three platforms. These spray beams supply pressurized water, conveyed by a pump with filter arranged on the bottom of the water layer, to clean the lenses on top of the troughs during night-time cleaning periods, and during sand-storms.

On top of the pillar there is a vertical rod connecting to the ends of the spray beams, which have the form of flattened tubes.

In platforms with optical or radio signal transmitters, these are also mounted on these rods.

### BRIEF DESCRIPTION OF THE DRAWINGS

FIG. 1 shows a plan view of a platform with troughs.

FIG. 2 shows a group with three platforms.

FIG. 3 shows a side-view of FIG. 2.

FIG. 4 shows a plurality of groups.

### DESCRIPTION OF THE PREFERRED EMBODIMENTS OF THE INVENTION

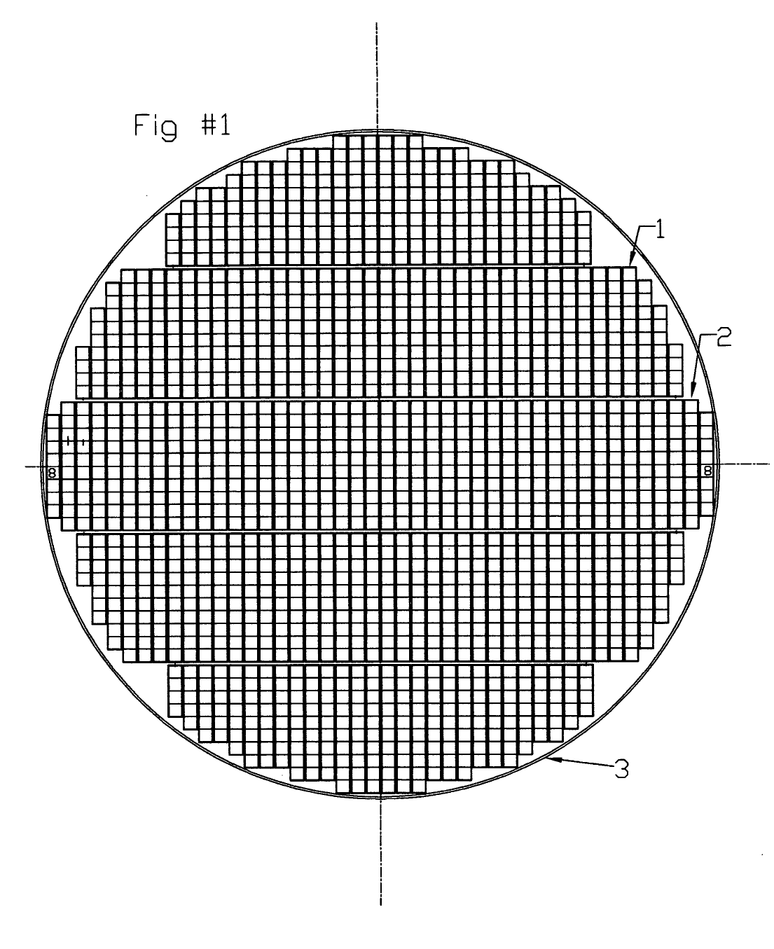

FIG. 1 shows a platform in plan-view. The troughs 1 are arranged in five rows. They can follow the sun's elevation by turning around their horizontal axis 2. The troughs 1 are surrounded by a floating ring 3.

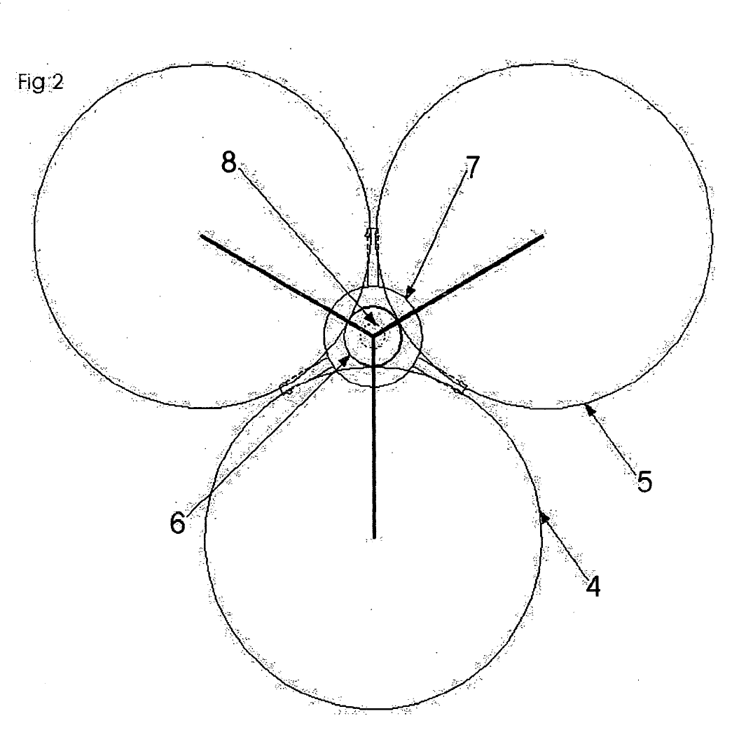

FIG. 2 shows a triad of platforms 4, 5 and 5′. Central pillar 8 is mounted on concrete slab socket 7, which carries drive wheel 6. Instead of a single drive wheel, three drive wheels can be arranged 120° apart.

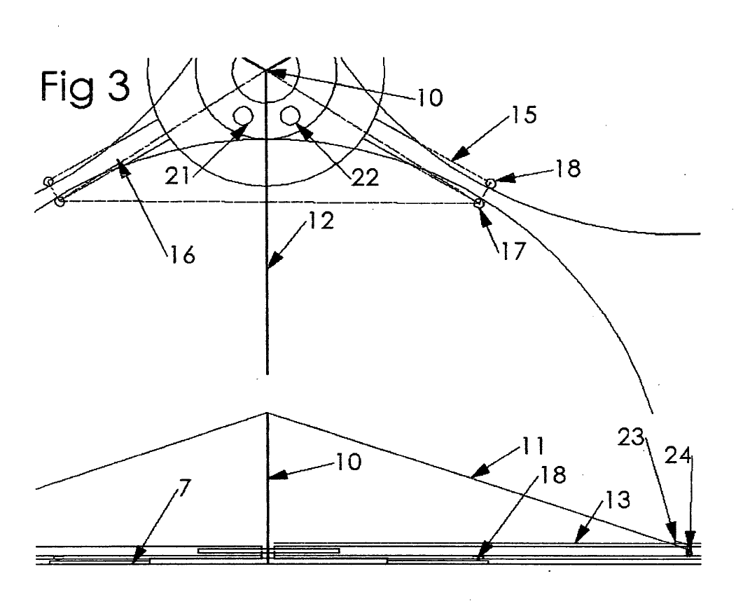

FIG. 3 shows side view (below) and top view. Central rod 10 acts as vertical support from which extend copper profiles 11 holding the ends of the spray beams 12 with their downward pointing nozzles (not shown). The copper profiles 11 keep the spray beams horizontal within a small distance above each platform. The copper profiles 11 act also as conductor for the positive polarity, while insulated lead 13, above spray beam 12, conducts the negative polarity. Both leads 11 and 13 continue as insulated conductors that run through a metal tube (not shown) and then to an underwater installation. Three metal channels 15 and 16 form a unit with the cement-slab socket 7. Two rollers 17 and 18 are fixed to their ends, and lie within the platform to roll on small ring area 19. At the end of the spray beams, conducting elements 24 are attached to two highly insulated leads 23 coming from the middle of the platform.

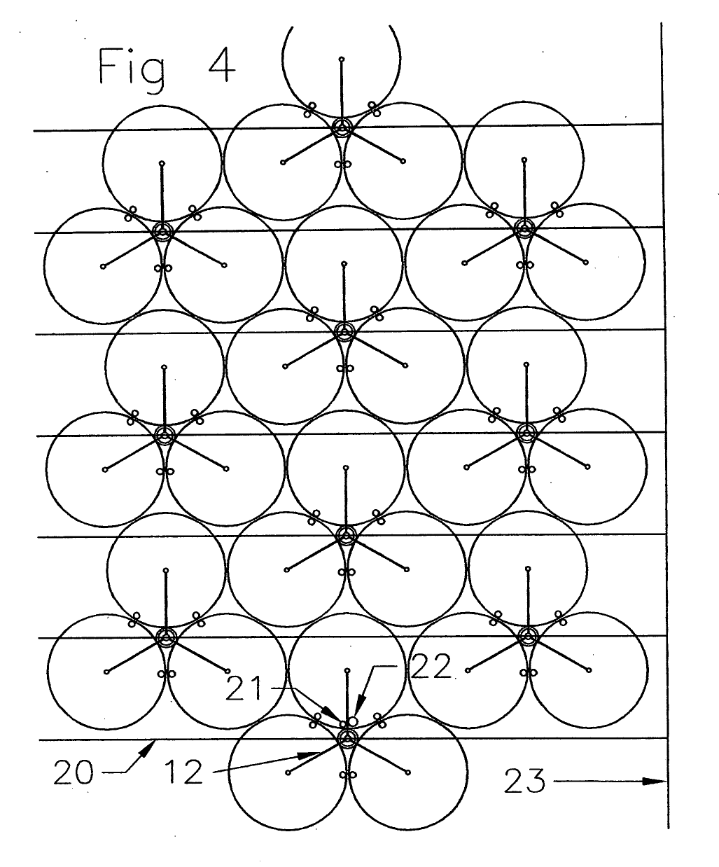

FIG. 4 shows the arrangement of multiple triads of circular platforms, as well as electric conductors 20 below the water which lead the electricity of a row of triads to a junction cable 23. Pumps 21 and filters 22 take water from the bottom of the water body and feed it to the spray-beam 12, to clean the platforms' concentrator lenses during night hours. During these cleaning periods the platforms turn beneath the fixed spray-beams, at least 360 degrees around their vertical axes. An increased cleaning action can be achieved by attaching a textile cloth to the spray-beam, for touching the lenses while cleaning.

It is also possible to position the platforms on ponds and lakes. In this case the central pillar would float. To stabilize its orientation, a dense weight is positioned on its bottom.

Alternatively, a gear wheel can be arranged between the central drive wheel and the platforms. In this case, the invention uses a gear wheel with rubber-elastic teeth that mesh with extensions stamped into a sheet-metal strip fixed to the floating ring.

1. A system for the production of solar electricity, comprising rotating solar electricity producing circular platforms with vertical axes of rotation, said platforms comprising multiple concentrating lenses, with three of said platforms comprising a triad having an interstitial pillar, said pillar comprising means to transmit torque to rotate said platforms

2. The system of claim 1, in which each said platform comprises a circumferential floating ring.

3. The system of claim 2, with said floating rings having toothed rims, each forming a gear wheel.

4. The system of claim 1 also comprising an upper spray beam arranged between said pillar and the centers of said platforms, said beam spraying water onto the top of said platforms, said platforms rotating under said spray being to wash all parts of said platform during night-time or dust-storm cleanings.

5. The system of claim 4, also comprising textile strips attached to said spray beams, said strips wetted by said spray beams, said strips touching said lenses during said cleaning period.

6. The system of claim 1, each said platform also comprising a central bearing-element connected via said spray beam with said central pillar.

7. The system of claim 2, wherein said torque-transmitting means comprises a wheel-disc that transmits tracking torque to said floating rings.

8. The system of claim 1 wherein electricity is conducted highly flexible electrical leads from the center to the upper side of said platform, whereby the ends of said leads are fixed to a stationary insulated element, said element electrically connected with said central pillar.

9. The system of claim 3, wherein said central pillar is connected to a support socket.

10. The system of claim 9, in which said central pillar also comprises a drive wheel engaging three of said platforms.

11. The system of claim 10, also comprising three driving rollers transmitting torque to said three platforms.

12. The system of claim 1, floating on a natural water body, such as a lake, wherein said central pillar comprises a body with higher density than water at its lower end and lower density than water at its upper end.

13. The system of claim 12, wherein said central pillar is fixed to prevent both horizontal motion and rotation.

14. The system of claim 10, said support socket of said central pillar also comprising guide rollers reaching within each said floating ring.

15. The system of claim 14, wherein said floating ring is fixed in position between the inside of said peripheral two rollers and said wheel-disc.

16. The system of claim 14, wherein said two guide-rollers engage of each of three said platforms form and equilateral triangle centered on said wheel-disc.

17. The system of claim 3, wherein a sheet-metal strip is fixed to said floating ring and comprises said toothed rim.

18. The system of claim 17, wherein the gear-teeth of said wheel-disc on said central pillar are comprised of a elastomeric material.

19. The system of claim 4, wherein the opposite end of said spray beam from said central pillar is connected by a rope-like connector to a vertical rod on said central pillar, said connector holding said spray beam in a horizontal position spaced vertically above said concentrator lenses.

20. The system of claim 19, wherein said rope-like connection is electrically conductive.
